(19) United States
(12) Patent Application Publication
(10) Pub. No.: US 2026/0123778 A1
(43) Pub. Date: May 7, 2026

(54) ASSEMBLIES INCLUDING TRAYS RECONFIGURABLE FOR RAW FOOD AND FOR COOKED FOOD

(71) Applicant: Grillbot, LLC, New York, NY (US)

(72) Inventor: Ethan WOODS, New York, NY (US)

(21) Appl. No.: 19/352,207

(22) Filed: Oct. 7, 2025

Related U.S. Application Data
(63) Continuation-in-part of application No. 29/977,540, filed on Dec. 9, 2024.
(60) Provisional application No. 63/716,076, filed on Nov. 4, 2024.
(60) Provisional application No. 63/717,161, filed on Nov. 6, 2024.

(51) Int. Cl. A47G 23/06; A47J 47/00; B65D 1/34; B65D 25/24

(52) U.S. Cl. CPC A47G 23/0633; A47G 23/0641; A47J 47/005; B65D 1/34; B65D 25/24; A47G 2023/0666; B65D 2313/04

(57) ABSTRACT

An assembly comprises a base and a tray including opposite first and second surfaces. The tray is coupled to the base such that the tray is rotatably reversible, flippable, or reconfigurable relative to the base between first and second configurations. In the first configuration, the first surface of the tray faces generally upward and/or is exposed for receiving raw food. Also in the first configuration, the assembly is configured for routing and containment of fluid, if any, from the raw food thereby inhibiting raw food fluid from reaching or contacting the second surface of the tray. In the second configuration, the second surface of the tray faces generally upward and/or is exposed for receiving cooked food. Also in the second configuration, the assembly is configured to provide a reservoir for receiving fluid, if any, from the cooked food and outlet(s) for pouring cooked food fluid from the reservoir.

### CROSS-REFERENCE TO RELATED APPLICATIONS

This application claims the benefit of and priority to U.S. Provisional Patent Application No. 63/716,076 filed Nov. 4, 2024 and to U.S. Provisional Patent Application No. 63/717,161 filed Nov. 6, 2024.

This application is a continuation-in-part of U.S. Design Patent Application No. 29/977,540 filed Dec. 9, 2024.

The entire disclosures of the above patent applications are incorporated herein by reference.

### FIELD

The present disclosure relates to assemblies including trays reconfigurable for raw food and for cooked food, such as food preparation serving tray combinations or assemblies, etc. The tray is rotatably reversible, flippable, or reconfigurable for providing a first surface for raw food (e.g., for preparation, holding, and/or cutting raw meat or fish, etc.) when in a first configuration and for providing an opposite second surface for cooked food (e.g., for preparation, holding, cutting, serving, and/or presentation of grilled meat or fish, etc.) after being rotatably reversed, flipped, or reconfigured from the first configuration to a second configuration.

### BACKGROUND

This section provides background information related to the present disclosure which is not necessarily prior art.

A cutting board serving tray combination is a dual purpose kitchen tool that combines the functions of a cutting board and a serving tray. Conventional cutting board serving tray combinations are typically made from wood, bamboo, or plastic and include a flat surface suitable for chopping ingredients and preparing food. After preparation, the same cutting board serving tray combination may be used to serve the food, making it ideal for charcuterie boards, appetizers, or even main dishes. The dual-purpose tool may save space and add convenience in the kitchen and at the dining table.

### DRAWINGS

The drawings described herein are for illustrative purposes only of selected embodiments and not all possible implementations and are not intended to limit the scope of the present disclosure.

FIG. 1 is a perspective view of an assembly including a tray that is rotatably reversible, flippable, or reconfigurable for providing a first surface for raw food (e.g., for preparation, holding, and/or cutting raw meat or fish, etc.) and an opposite second surface for cooked food (e.g., for preparation, holding, cutting, serving, and/or presentation of grilled meat or fish, etc.) according to an exemplary embodiment of the present disclosure.

FIG. 2 is a bottom perspective view of the assembly shown in FIG. 1.

FIG. 3 includes an overview of various example features that may be included in the assembly shown in FIGS. 1 and 2.

FIG. 4 is another perspective view of the assembly shown in FIG. 1 with the utensils removed from the utensil holders and with the first surface (raw side) of the tray facing generally upward and/or is exposed for receiving raw food (e.g., for preparation, holding, and/or cutting raw meat or fish, etc.).

FIGS. 5 and 6 are perspective views of the assembly shown in FIG. 4 as the tray is being rotatably reversed, flipped, or reconfigured relative to the base from the first (“raw side up”) configuration shown in FIG. 4 to a second (“cooked side up”) configuration shown in FIG. 7.

FIG. 7 is a perspective view of the assembly shown in FIGS. 4, 5, and 6 after the assembly has been transitioned into the second configuration in which the second surface (cooked side) of the tray is facing generally upward and/or is exposed for receiving cooked food (e.g., for preparation, holding, cutting, serving, and/or presentation of grilled meat or fish, etc.).

FIG. 8 is an exploded perspective view of the assembly shown in FIGS. 1 to 7.

FIG. 9 is another exploded perspective view of the assembly shown in FIG. 8 in which labels have been added to the various components for purposes of illustration and convenience only and not for purposes of limitation.

FIG. 10 includes top, side, and end views of the assembly shown in FIG. 1 along with exemplary dimensions that may be used in an exemplary embodiment of the present disclosure.

FIG. 11 is a cross-sectional view of a portion of the assembly shown in FIG. 1 and illustrating a roller rail system that may be used to couple the tray to the base according to an exemplary embodiment of the present disclosure.

FIG. 12 is a perspective view of a portion of the assembly shown in FIG. 1 and illustrating example utensil slot or holder details labeled with icons of a fork and spatula that may be used in an exemplary embodiment of the present disclosure.

FIG. 13 is a perspective view of a portion of the assembly shown in FIG. 1 and illustrating an example stainless steel facia and example utensil slot or holder details labeled with icons of tongs and a basting brush that may be used in an exemplary embodiment of the present disclosure.

FIG. 14 is a perspective view of a portion of the assembly shown in FIG. 1 and illustrating example embossed text and logo that may be used in an exemplary embodiment of the present disclosure.

FIG. 15 is a perspective view of an assembly along with examples surface finishes (e.g., gloss, Pantone Matching System (PMS) cool gray 8, PMS cool gray 2 MT-11040, PMS cool gray 8 MT-11040) that may be used in an exemplary embodiment of the present disclosure.

### DETAILED DESCRIPTION

Example embodiments will now be described more fully with reference to the accompanying drawings.

Disclosed herein are exemplary embodiments of assemblies including trays reconfigurable for raw food and for cooked food. The tray is rotatably reversible, flippable, or reconfigurable for providing a first surface for raw food (e.g., for preparation, holding, and/or cutting raw meat or fish, etc.) when in a first configuration and for providing an opposite second surface for cooked food (e.g., for preparation, holding, cutting, serving, and/or presentation of grilled meat or fish, etc.) after being rotatably reversed, flipped, or reconfigured from the first configuration to a second configuration.

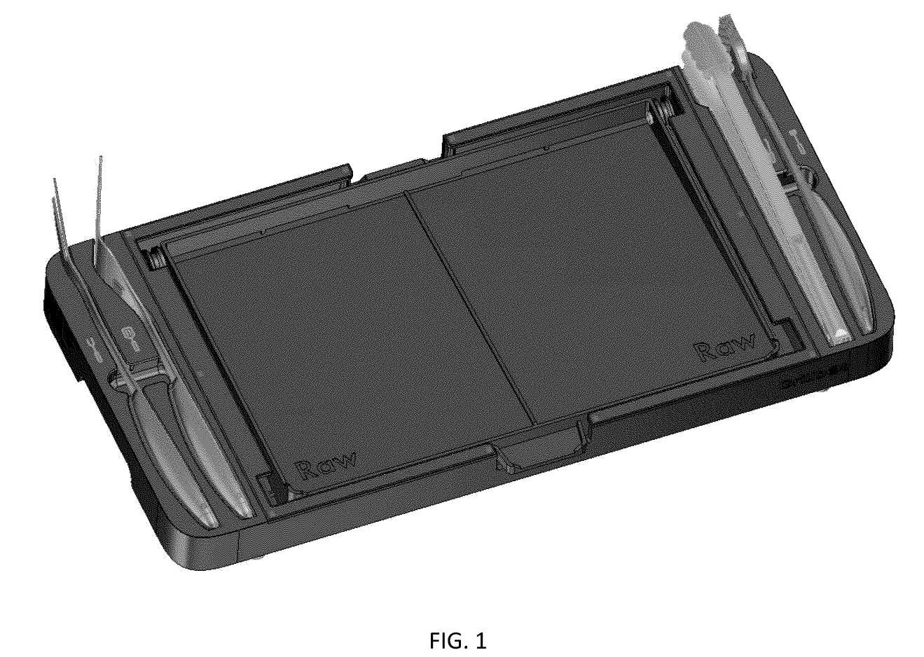

In exemplary embodiments disclosed herein, an innovative two-sided cutting board (broadly, assembly) features distinct surfaces for raw and cooked foods. The assembly has a one-handed flip actuation that allows for easy switching between sides, enhancing user convenience. The innovative design of the assembly includes designated utensil locations to keep cooking tool(s) (e.g., fork, spatula, tongs, basting brush) organized during food preparation. For example, cooking tool(s) may be frictionally retained in grooves/slots, such as shown in FIG. 1, etc. Or, for example, cooking tool(s) may be magnetically attached, such as shown in Appendix A, etc. The assembly is configured to effectively manage raw fluid routing and containment while offering a cooked juice reservoir with pouring corners for mess-free serving. For example, the assembly may include special ridges (e.g., as shown in Appendix A, etc.) to channel liquid away. Cleaning is simplified with the easily removable inner tray. And the top surface is available in stainless steel, textured polymer, etc. Additional user-friendly features include large side handles, pad-printed icons for utensil locations, and non-slip press-in rubber feet or non-slip silicone rubber feet. The materials used in the construction are food safe and dishwasher safe thereby providing an effortless maintenance and durability.

Appendix A includes features that may be included in assemblies including trays reconfigurable for raw food and for cooked food according to exemplary embodiments of the present disclosure. As shown in Appendix A, an exemplary embodiment of an assembly includes built-in magnets to hold cooking tool(s) (e.g., fork, spatula, tongs, basting brush) magnetically in place. The assembly is configured to effectively manage raw fluid routing and containment while offering a cooked juice reservoir with pouring corners for mess-free serving. In this exemplary embodiment, the assembly includes special ridges to channel liquid away. The assembly is configured to have a relatively large size (e.g., 17.4 inches×10.5 inches, etc.), is made from material that is free of Bisphenol-A (BPA-free material), is configured to not get too hot to manually carry, and is dishwasher safe. Cleaning is simplified with the easily removable top tray after aligning notches to center of tray and lifting to remove. The images, materials, dimensions, etc. shown in Appendix A are for illustrative purposes only of selected embodiment(s) and not all possible implementation(s) and are not intended to limit the scope of the present disclosure. The contents of Appendix A is incorporated herein by reference in its entirety.

With reference to the figures, FIG. 1 is a perspective view of an assembly according to an exemplary embodiment of the present disclosure. As shown in FIG. 1, the assembly is in a first configuration in which a first surface (raw side) of the tray is facing generally upward and/or is exposed for receiving raw food (e.g., for preparation, holding, and/or cutting raw meat or fish, etc.). Also shown in FIG. 1 are utensils (e.g., fork, spatula, tongs, and brush) positioned within the utensil holders (e.g., recessed portions of grooves, etc.) along the first and second handles for carrying the assembly.

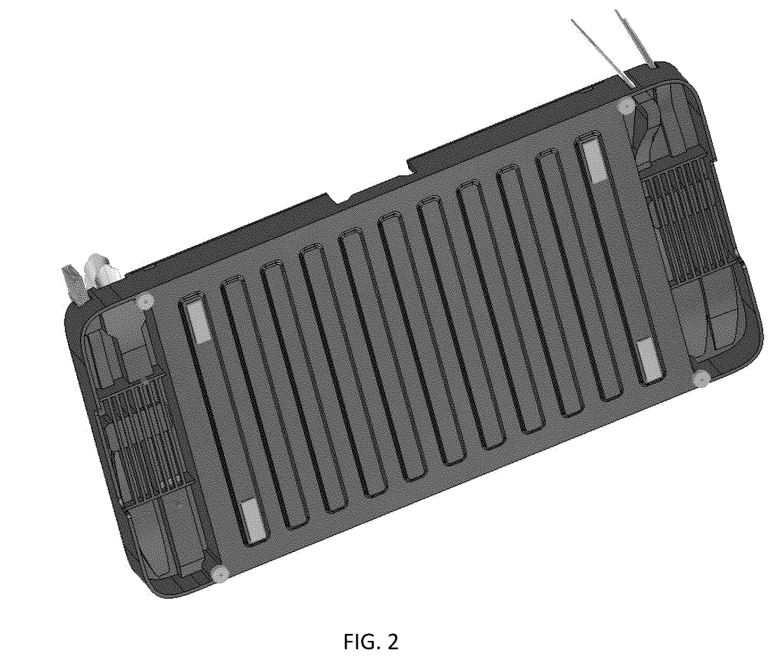

FIG. 2 is a bottom perspective view of the assembly shown in FIG. 1.

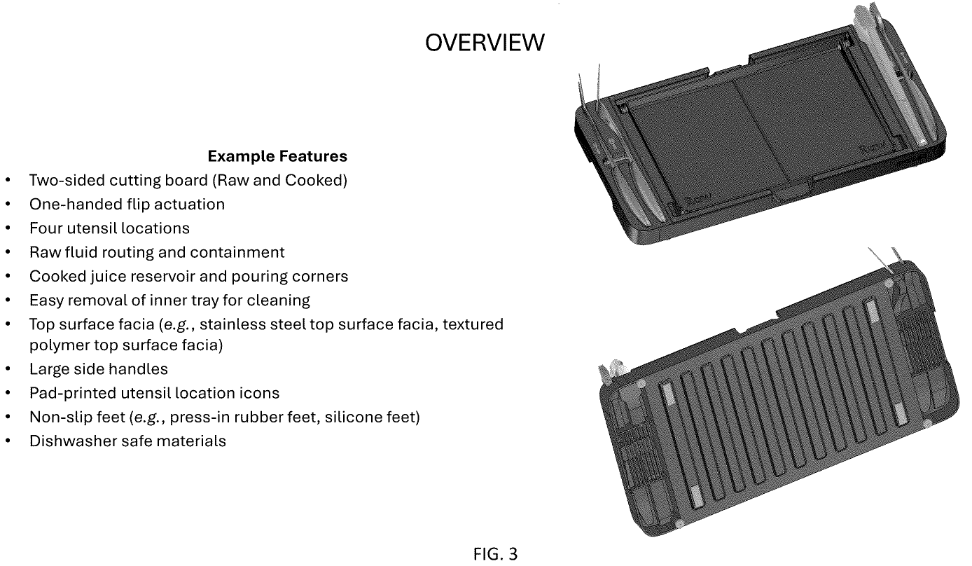

FIG. 3 includes an overview of various example features that may be included in the assembly shown in FIGS. 1 and 2. As listed in FIG. 3, an exemplary embodiment of an assembly may include:
Two-sided cutting board (Raw and Cooked);
One-handed flip actuation;
Four utensil locations;
Raw fluid routing and containment;
Cooked juice reservoir and pouring corners;
Easy removal of inner tray for cleaning;
Top surface facia (e.g., stainless steel top surface facia, textured polymer top surface facia) ;
Large side handles;
Pad-printed utensil location icons;
Non-slip feet (e.g., press-in rubber feet, silicone feet) ; and
Dishwasher safe materials.

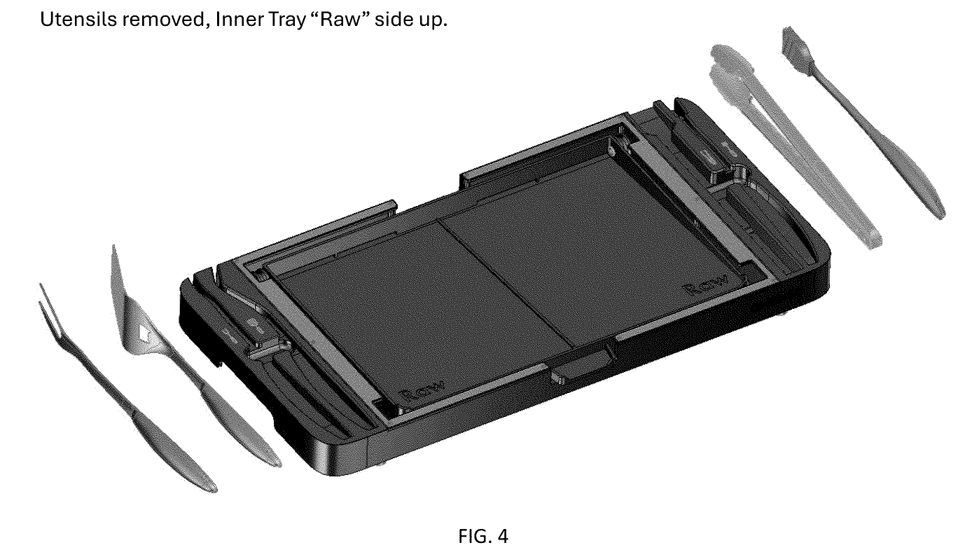

FIG. 4 is another perspective view of the assembly shown in FIG. 1 with the utensils removed from the utensil holders and with the first surface (raw side) of the tray is facing generally upward and/or is exposed for receiving raw food (e.g., for preparation, holding, and/or cutting raw meat or fish, etc.).

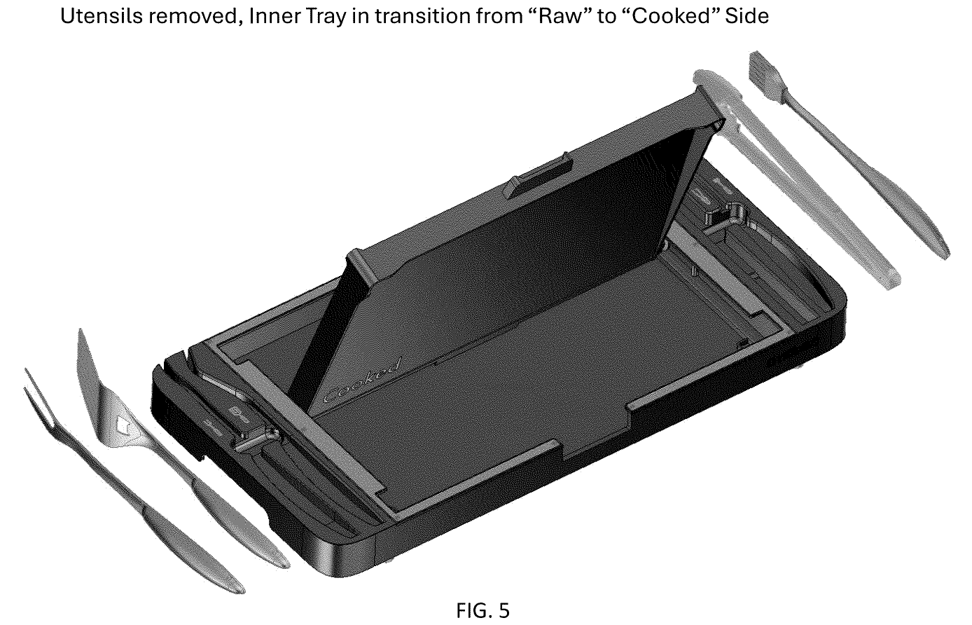

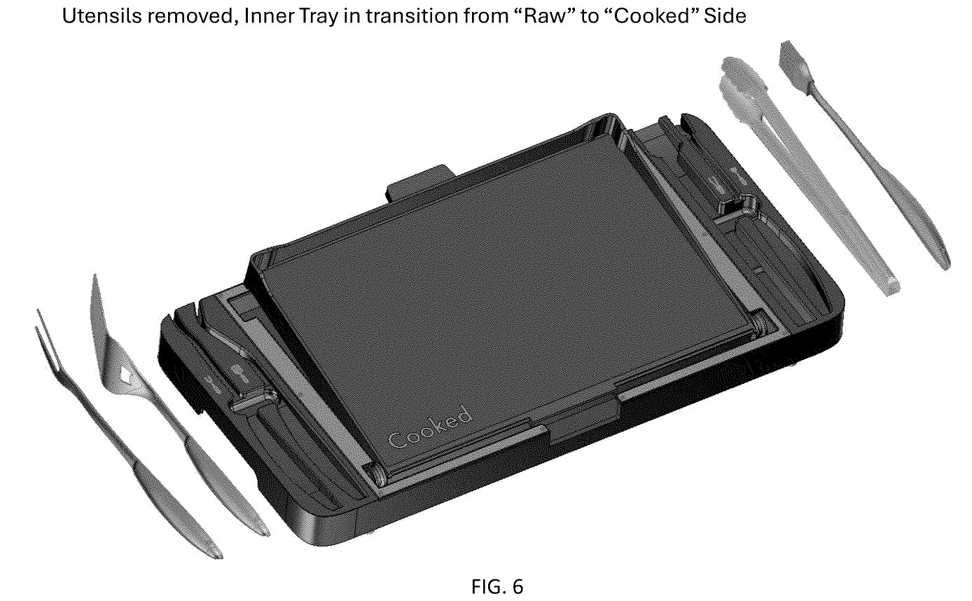

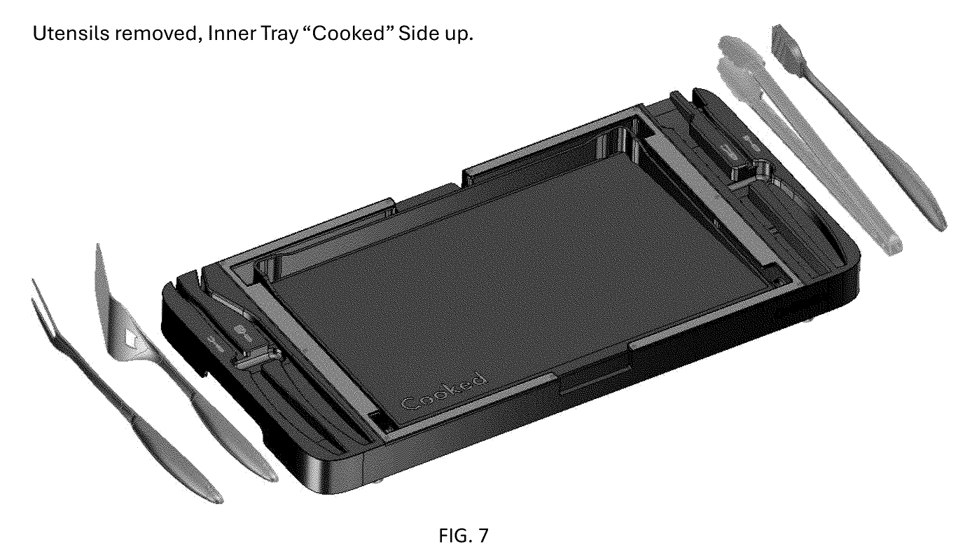

FIGS. 5 and 6 are perspective views of the assembly shown in FIG. 4 as the tray is being rotatably reversed, flipped, or reconfigured relative to the base from the first (“raw side up”) configuration shown in FIG. 4 to a second (“cooked side up”) configuration shown in FIG. 7.

FIG. 7 is a perspective view of the assembly shown in FIGS. 4, 5, and 6 after the assembly has been transitioned into the second configuration in which the second surface (cooked side) of the tray is facing generally upward and/or is exposed for receiving cooked food (e.g., for preparation, holding, cutting, serving, and/or presentation of grilled meat or fish, etc.).

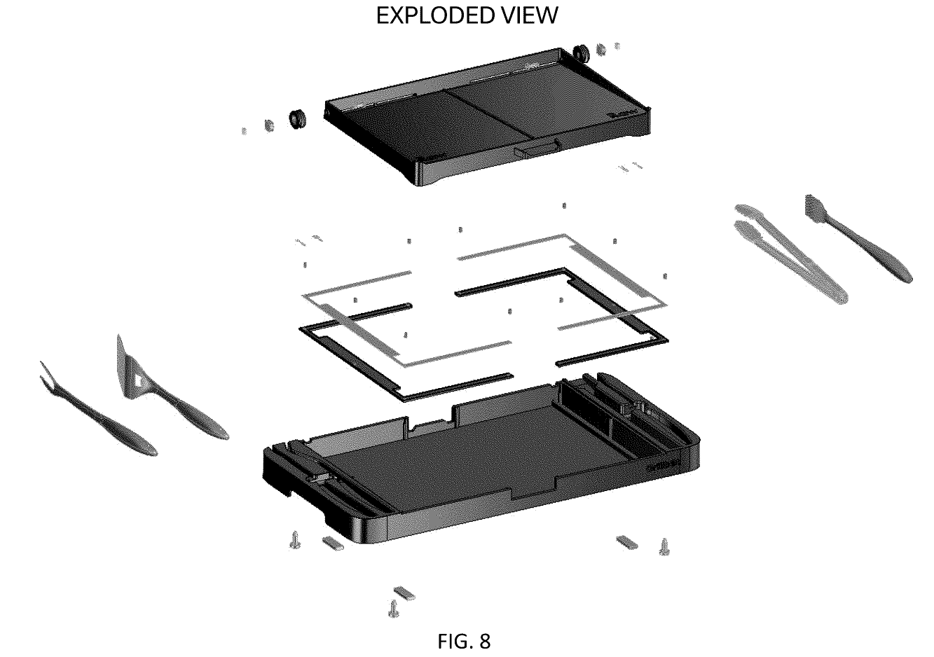

FIG. 8 is an exploded perspective view of the assembly shown in FIGS. 1 to 7.

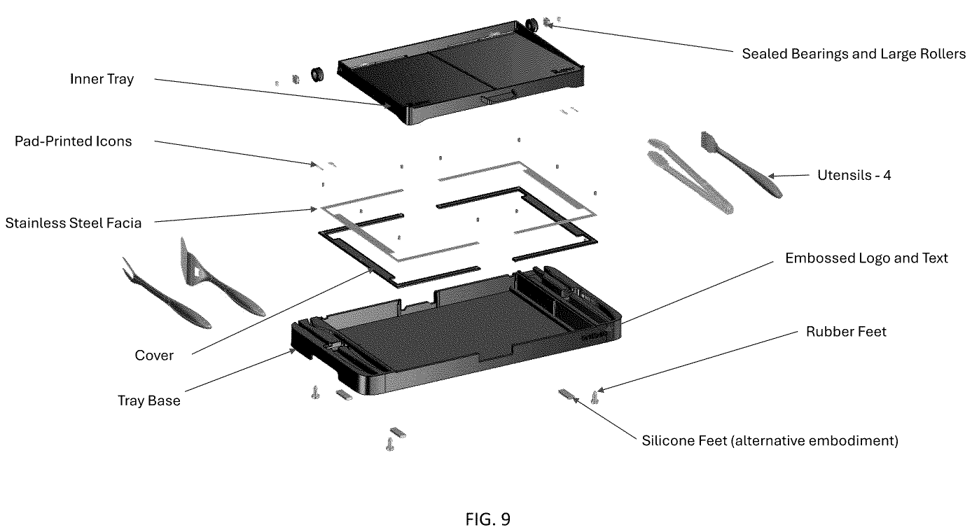

FIG. 9 is another exploded perspective view of the assembly shown in FIG. 8 in which labels have been added to the various components for purposes of illustration and convenience only and not for purposes of limitation. The labels shown in FIG. 9 include inner tray, pad-printed icons, stainless steel facia, cover, tray base, sealed bearings and large rollers, utensils - 4, embossed logo and text, rubber fees, and silicone feet (alternative embodiment).

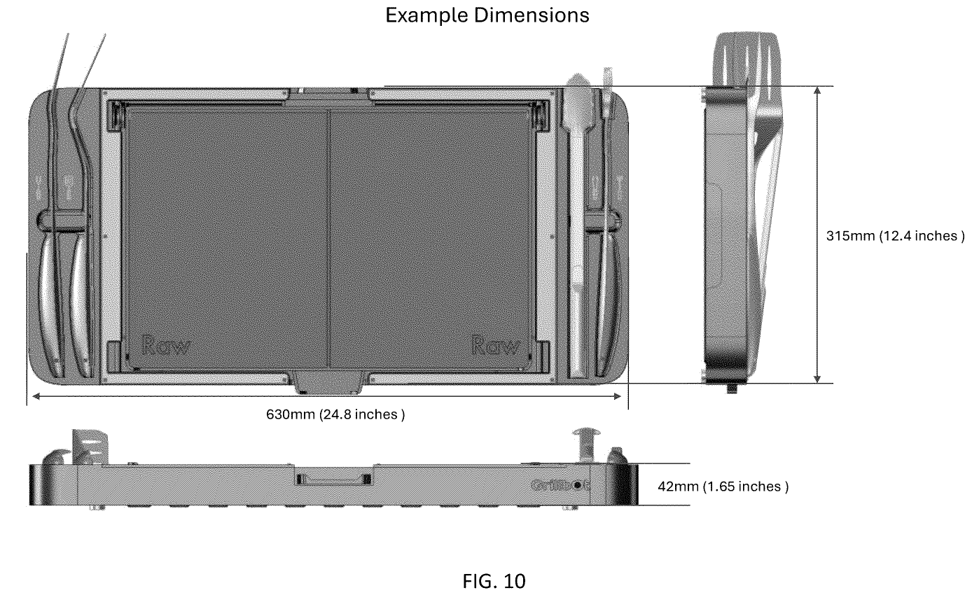

FIG. 10 includes top, side, and end views of the assembly shown in FIG. 1 along with exemplary dimensions that may be used in an exemplary embodiment of the present disclosure. In exemplary embodiments, the assembly (without any utensils) may have a weight of about 1.8 kilograms to about 1.9 kilograms (about 4 pounds to about 4.2 pounds) when made from high-density polyethylene (HDPE). The dimensions, weights, and materials provided herein are examples only as other exemplary embodiments may be configured differently, e.g., larger, smaller, heavier, lighter, different materials, etc.

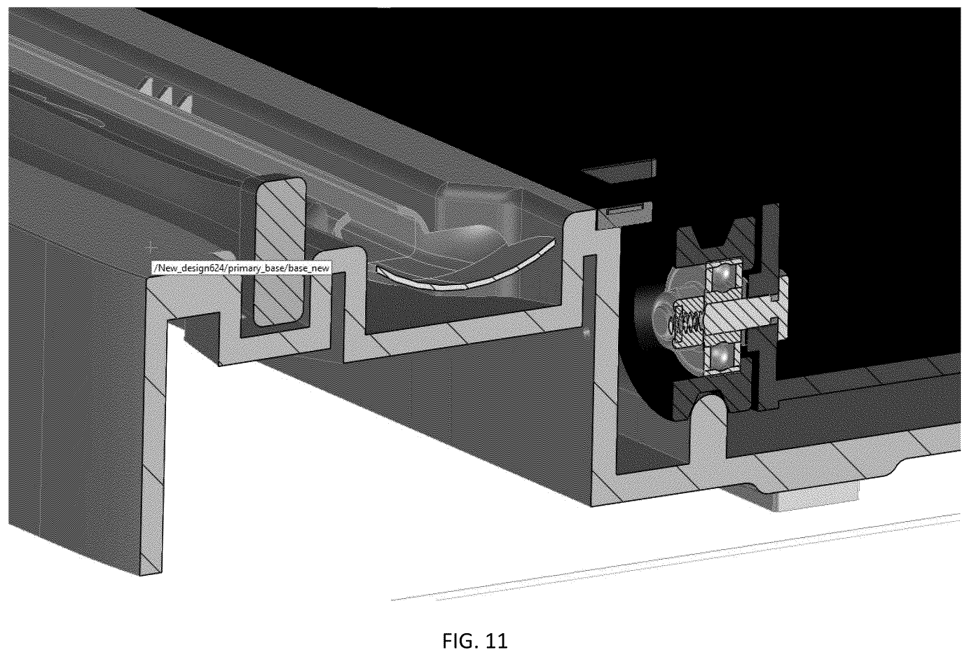

FIG. 11 is a cross-sectional view of a portion of the assembly shown in FIG. 1 and illustrating a roller rail system that may be used to couple the tray to the base according to an exemplary embodiment of the present disclosure. As shown in FIG. 11, a roller (e.g., acetal roller, etc.) is rotatably coupled (e.g., via mechanical fastener and bearings, etc.) to the tray and rollable along a rail of the base.

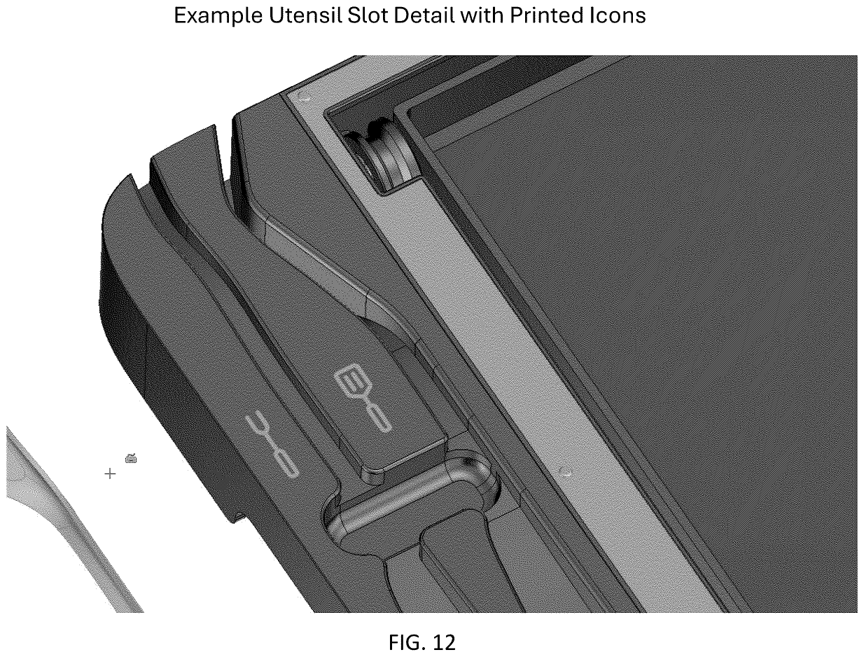

FIG. 12 is a perspective view of a portion of the assembly shown in FIG. 1 and illustrating example utensil slot or holder details labeled with icons of a fork and spatula that may be used in an exemplary embodiment of the present disclosure.

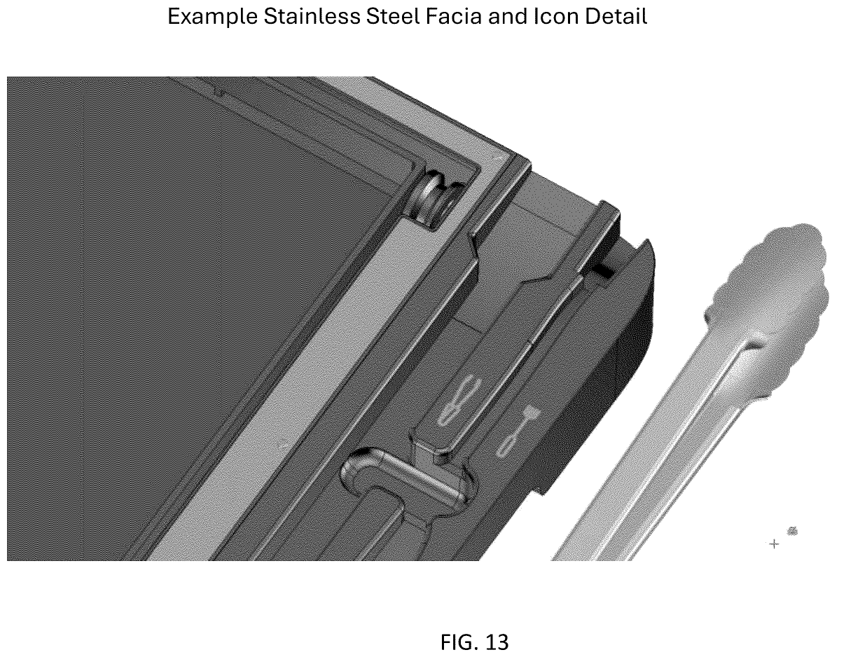

FIG. 13 is a perspective view of a portion of the assembly shown in FIG. 1 and illustrating example stainless steel facia and example utensil slot or holder details labeled with icons of tongs and a basting brush that may be used in an exemplary embodiment of the present disclosure.

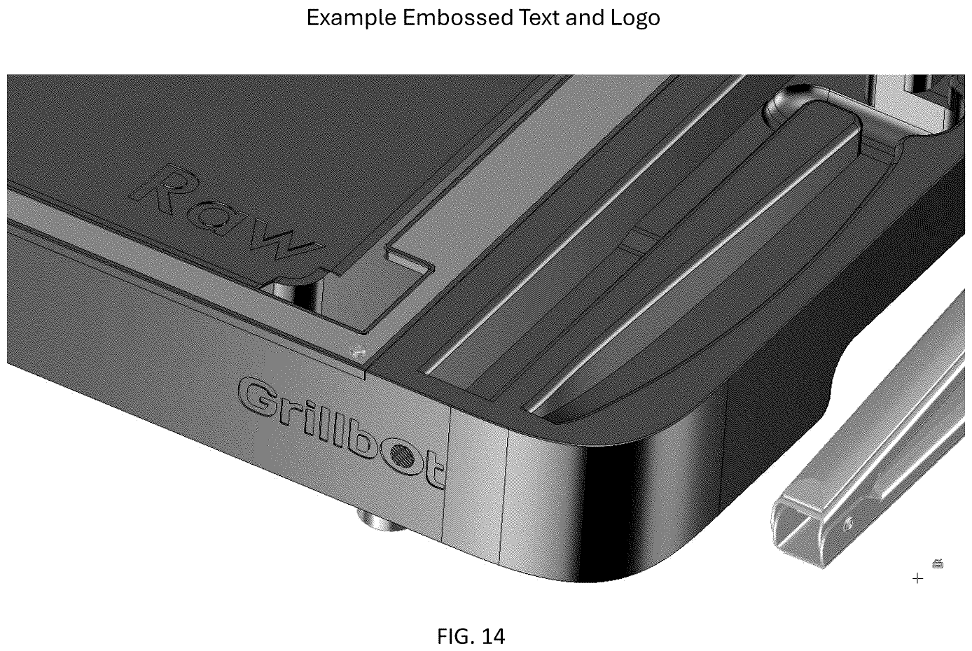

FIG. 14 is a perspective view of a portion of the assembly shown in FIG. 1 and illustrating example embossed text and logo that may be used in an exemplary embodiment of the present disclosure. The embossed surface may be polished, thus creating a contrast to tray texture.

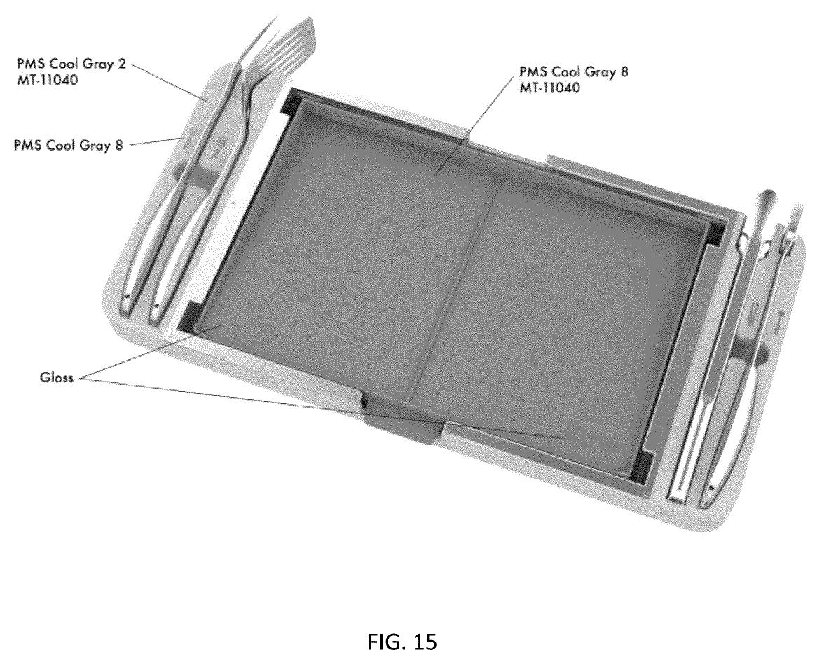

FIG. 15 is a perspective view of an assembly along with examples of surface finishes (e.g., gloss, Pantone Matching System (PMS) cool gray 8, PMS cool gray 2 MT-11040, PMS cool gray 8 MT-11040) that may be used in an exemplary embodiment of the present disclosure. These surface finishes are examples only as other exemplary embodiments may be configured differently, e.g., with one or more different or additional surface finishes than shown in FIG. 15, etc.

By way of example only, the following materials may be used for an assembly according to an exemplary embodiment. The flip tray or inner tray may be formed (e.g., via 3D printing, additive manufacturing, machining, etc.) from high-density polyethylene (HDPE). The base or base tray may be formed (e.g., via 3D printing, additive manufacturing, machining, etc.) from polypropylene (PP). The rollers coupled to the tray may be formed from acetal. The materials and manufacturing processes provided herein are examples only as other exemplary embodiments may be configured differently, e.g., made from different materials and/or via other manufacturing processes, etc. For example, polypropylene (PP), nylon, and HDPE are good material options for the tray and the base. Polypropylene (PP) is relatively low cost, high quality, and compatible with over-molding if rubber features are desired. Nylon and HDPE provide increased durability (harder) but will wear out knives more quickly. HDPE resists moisture and is less likely to stain. Nylon is more flexible and resistant to cracking but tends to be more expensive. Acetal is a good option for sliding surfaces (rollers). The materials including additives therein that are selected for the assembly should preferably be food safe.

By way of further example, the base may be formed via 3D printing with a secondary process such as paint to represent final molded part look and feel. Machining is also an option for the base but would be relatively costly due to the size and complex ID features of the base. The tray may be machined from HDPE in a color approximate to desired final product color.

In exemplary embodiments, an assembly comprises a base and a tray. The tray includes opposite first and second surfaces. The tray is coupled to the base such that the tray is rotatably reversible, flippable, or reconfigurable relative to the base between a first configuration and a second configuration. In the first configuration, the first surface of the tray faces generally upward and/or is exposed for receiving raw food (e.g., for preparation, holding, and/or cutting raw meat or fish, etc.). Also in the first configuration, the assembly is configured for routing and containment of fluid, if any, from the raw food thereby inhibiting raw food fluid from reaching or contacting the second surface of the tray. In the second configuration, the second surface of the tray faces generally upward and/or is exposed for receiving cooked food (e.g., for preparation, holding, cutting, serving, and/or presentation of grilled meat or fish, etc.). Also in the second configuration, the assembly is configured to provide a reservoir for receiving fluid, if any, from the cooked food and one or more outlet(s) (e.g., pouring corners, etc.) for pouring cooked food fluid from the reservoir.

In exemplary embodiments, the assembly includes a one-handed flip actuation mechanism that allows a user to easily and/or single-handedly reverse, switch, or flip the tray between the first configuration and the second configuration.

In exemplary embodiments, the tray is coupled to the base via an actuation mechanism that allows a user to single-handled flip the tray over between the first configuration and the second configuration.

In exemplary embodiments, the tray is coupled to the base via a rail roller system.

In exemplary embodiments, the base includes or defines first and second rails extending along the base. First and second rollers are rotatably coupled to the tray and rollable along the respective first and second rails of the base.

In exemplary embodiments, the tray is coupled to the base via a hinge, pivot, or rail roller system that allows the tray to be rotatably reversed, switched, or flipped over by a user without using both hands.

In exemplary embodiments, the first surface of the tray is labeled and/or designated for raw food preparation. And the second surface of the tray is labeled and/or designated for cooked food preparation, serving, and/or presentation.

In exemplary embodiments, the assembly includes first and second handle portions for carrying the assembly. The first and second handle portions may be integrally formed respectively along opposite first and second end portions of the tray. The first and second handle portions may be configured to provide or include utensil holders for holding and/or storage of cooking utensils. The first and second handle portions may provide relatively large side handles for enhanced grip and maneuverability of the assembly. The first and second handle portions may integrally include or define utensil storage grooves, slots, or recessed portions configured to receive at least portions of cooking utensils therein for frictionally retaining (e.g., via friction interference fit, etc.), holding, and/or storing the cooking utensils therein. The utensil storage grooves, slots, or recessed portions of the first and second handle portions may be configured to receive respectively a spatula, tongs, basting brush, and fork, e.g., thereby providing four designated locations for utensil storage to facilitate organized food preparation. The utensil storage grooves, slots, or recessed portions of the first and second handle portions may include pad-printed utensil location icons corresponding to the spatula, tongs, basting brush, fork, or other utensil to be stored therein.

In exemplary embodiments, the assembly includes one or more magnets for magnetic attachment of one or more magnetic cooking utensils to the assembly. The one or more magnetic cooking utensils (e.g., spatula, tongs, basting brush, fork, etc.) may be made of metal, ferromagnetic material, and/or other magnetic material. In such exemplary embodiments, the base may include one or more embedded or built-in magnets for magnetic attachment of the one or more magnetic cooking utensils. The assembly may include opposite first and second handle portions for carrying the assembly. The one or more magnets may be located above the first and second handle portions. The first and second handle portions may be integrally formed respectively along opposite first and second end portions of the base. And the one or more magnets may be along the base above the first and second handle portions.

In exemplary embodiments, the fluid routing and containment system is integrally formed or integrated into the tray, such that in the first configuration, the fluid routing and containment system is operable for routing and containing fluid, if any, from the raw food on the first surface of the tray to thereby inhibit raw food fluid from reaching or contacting (e.g., prevent bacteria and cross contamination, etc.) the second surface of the tray. The raw food fluid routing and containment system may include built in drain areas to dispose of raw liquid while saving cooked food fluid (e.g., cooked gravy, etc.) for use separately. The fluid routing and containment system may include grooves or channels to direct or channel raw food fluid away from the cooked food preparation area of the second surface.

In exemplary embodiments, the tray includes pouring corners configured to provide or define the one or more outlet(s) for pouring cooked food fluid from the reservoir, e.g., for mess-free serving of cooked food juice(s) or liquid(s), cooked gravy, etc.). In exemplary embodiments, the reservoir includes a sloped configuration (e.g., about a 5 degree downward slope, etc.) to facilitate routing of cooked food fluid towards the pouring corners of the tray and/or to facilitate the pouring of cooked food fluid from the reservoir via the pouring corners of the tray.

In exemplary embodiments, the tray is removable from the base. For example, the tray may be relatively easily removable from the base for simplified cleaning of the tray and the base, etc.

In exemplary embodiments, the assembly includes a stainless top surface facia or a textured polymer top surface facia.

In exemplary embodiments, the assembly is made from materials that are food safe and dishwasher safe, e.g., for easy maintenance and durability, etc.

In exemplary embodiments, the base includes non-slip feet comprising press-in rubber feet or silicone feet.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. For example, when permissive phrases, such as “may comprise”, “may include”, and the like, are used herein, at least one embodiment comprises or includes the feature(s). As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An assembly comprising a base and a tray including opposite distinct first and second surfaces, the tray is coupled to the base such that the tray is rotatably reversible, flippable, or reconfigurable relative to the base between a first configuration and a second configuration, wherein:
in the first configuration, the first surface of the tray faces generally upward and exposed for receiving raw food, and the assembly is configured to include or provide a fluid routing and containment system for fluid, if any, from the raw food thereby inhibiting raw food fluid from reaching or contacting the second surface of the tray; and
in the second configuration, the second surface of the tray faces generally upward and exposed for receiving cooked food, and the assembly is configured to provide a reservoir for receiving fluid, if any, from the cooked food and one or more outlet(s) for pouring cooked food fluid from the reservoir.

2. The assembly of claim 1, wherein the assembly includes a one-handed flip actuation mechanism that allows a user to easily and/or single-handedly reverse or flip the tray between the first configuration and the second configuration.

3. The assembly of claim 1, wherein the tray is coupled to the base via an actuation mechanism that allows a user to single-handled flip the tray over between the first configuration and the second configuration.

4. The assembly of claim 1, wherein the tray is coupled to the base via a rail roller system.

5. The assembly of claim 1, wherein:
the base includes or defines first and second rails extending along the base; and
first and second rollers are rotatably coupled to the tray and rollable along the respective first and second rails of the base.

6. The assembly of claim 1, wherein the tray is coupled to the base via a rail roller system that allows the tray to be rotatably reversed or flipped over by a user without using both hands.

7. The assembly of claim 1, wherein the assembly includes opposite first and second handle portions for carrying the assembly.

8. The assembly of claim 7, wherein the first and second handle portions are integrally formed respectively along opposite first and second end portions of the base and configured to provide or include utensil holders for holding and/or storage of cooking utensils.

9. The assembly of claim 8, wherein the first and second handle portions integrally include or define utensil storage grooves, slots, or recessed portions configured to receive at least portions of cooking utensils therein for frictionally retaining, holding, and/or storing the cooking utensils therein.

10. The assembly of claim 9, wherein the utensil storage grooves, slots, or recessed portions of the first and second handle portions are configured to respectively receive therein a spatula, tongs, basting brush, and fork.

11. The assembly of claim 10, wherein the utensil storage grooves, slots, or recessed portions of the first and second handle portions include pad-printed utensil location icons corresponding to the spatula, tongs, basting brush, and fork.

12. The assembly of claim 1, wherein the assembly includes one or more magnets for magnetic attachment of one or more magnetic cooking utensils to the assembly.

13. The assembly of claim 12, wherein the base includes one or more embedded or built-in magnets for magnetic attachment of one or more magnetic cooking utensils to the base.

14. The assembly of claim 12, wherein:
the assembly includes opposite first and second handle portions for carrying the assembly; and
the one or more magnets are located above the first and second handle portions.

15. The assembly of claim 14, wherein:
the first and second handle portions are integrally formed respectively along opposite first and second end portions of the base; and
the one or more magnets are along the base above the first and second handle portions.

16. The assembly of claim 1, wherein the fluid routing and containment system is integrally formed or integrated into the tray, such that in the first configuration, the fluid routing and containment system is operable for routing and containing fluid, if any, from the raw food on the first surface of the tray to thereby inhibit raw food fluid from reaching or contacting the second surface of the tray.

17. The assembly of claim 16, wherein the fluid routing and containment system includes grooves or channels to direct raw food fluid away from the cooked food preparation area of the second surface.

18. The assembly of claim 1, wherein the tray includes pouring corners configured to provide or define the one or more outlet(s) for pouring cooked food fluid from the reservoir.

19. The assembly of claim 18, wherein the reservoir includes a sloped configuration to facilitate routing of cooked food fluid towards the pouring corners of the tray and/or to facilitate the pouring of cooked food fluid from the reservoir via the pouring corners of the tray.

20. The assembly of claim 1, wherein:
the tray is removable from the base; and/or
the assembly a stainless top surface facia or a textured polymer top surface facia; and/or
the assembly is made from materials that are food safe and dishwasher safe; and/or
the base includes non-slip feet comprising press-in rubber feet or silicone feet.
